(19) United States
(12) Patent Application Publication
(10) Pub. No.: US 2020/0045984 A1
(43) Pub. Date: Feb. 13, 2020

(54) Device For Forming A Dough Strip

(71) Applicant: König Maschinen Gesellschaft m.b.H, Graz (AT)

(72) Inventors: Hannes Stelzer, Lannach (AT); Eduard Rauch, St. Margarethen (AT); Markus Radl, Fürstenfeld (AT); Wolfgang Staufer, Wien (AT)

(21) Appl. No.: 16/343,030

(22) PCT Filed: Oct. 20, 2017
(86) PCT No.: PCT/AT2017/060280

§ 371 Date: Apr. 18, 2019

(30) Foreign Application Priority Data
Oct. 21, 2016 (AT) A50967/2016

(51) Int. Cl. A21C 3/02

(52) U.S. Cl. CPC A21C 3/024

(57) ABSTRACT

A device for forming a dough strip, including a dough supply device, by means of which dough can be introduced into the device, a draw-in roller which can be rotated about its axis, a forming roller which can be rotated about its axis, a discharge roller which can be rotated about its axis, and at least one drive, by means of which the draw-in roller and/or the forming roller and/or the discharge roller can be driven. The axes of the draw-in roller, the forming roller, and the discharge roller are arranged parallel to one another in a mutually spaced manner, and a dough chamber is formed between the draw-in roller, the forming roller, and the discharge roller. The device has two cover shields which laterally delimit the dough chamber, in particular on the end faces of the draw-in roller, the forming roller, and the discharge roller.

### TECHNICAL FIELD mon The present teaching relates to a device for forming a dough strip.

### BACKGROUND

There are various devices known from the prior art that form one or more batches of dough into a dough strip by means of pressing and form rollers. Such devices are also known by names such as “roller mills” or “dough strip formers,” and so on. Devices known from the prior art are primarily employed in the production of pastry delicacies, and enjoy increasing favor because of their low costs and ease of operation. As the result of constant development, such devices are also employed individually for leavened doughs or for other types of dough for baked goods. A disadvantage in systems known in the prior art is that the leavened doughs are subjected to too much pressure and the devices are difficult to clean, especially in using adhesive doughs, so that they cannot meet the constantly stricter hygienic requirements, or can do so only partially. Because of the required pressures and drive power, the structure of these roller units tends to require supports arranged on both sides of the rollers. The drive elements on both sides make cleaning and operation especially difficult and costly, and thus the hygienic requirements can be met only at considerable expense.

### SUMMARY

It is therefore one object of the present teaching to provide a device of the aforementioned type, which makes simple cleaning of the device possible and is capable of processing a wide range of doughs.

This object is achieved by the defining features of the present teaching. Such features foresee that the draw-in roller, the forming roller and the discharge roller are supported in a floating manner and that the supports of the draw-in roller, forming roller and discharge roller are arranged on one side of the device beside the dough chamber. As a result of the floating support, the device comprises a machinery side on which the drive elements and supports are arranged, and an operating side on which the rollers and the dough chamber are accessible. In particular, this results in clear facilitation of cleaning and maintenance, since no machine parts block access to the dough chamber and the rollers.

To protect the supports and drive elements of the device from contamination, the present teaching foresees that the supports of the draw-in roller, forming roller and discharge roller are mounted in a support housing, which in particular is hermetically insulated.

In addition, because of the hermetic sealing of the drive and support elements of the device, reduced expenditure is required for cleaning because the most commonly applied, more aggressive cleaning agents cannot penetrate to the supports and drive elements of the rollers.

One advantageous embodiment of the inventive device foresees that the device comprises a pivot device, so that the draw-in roller and/or forming roller and/or discharge roller can be pivoted by means of the pivot device, such that the distance of the axis of the draw-in roller and/or of the forming roller and/or of the discharge roller can be adjusted in relation to the axes of at least one of the other respective rollers. Because of the arrangement of the rollers or individual rollers on a pivot device, it is possible to enlarge the dough chamber by pivoting the individual rollers and thereby to facilitate cleaning. In addition, it becomes possible by pivoting the forming roller or the discharge roller to adjust the gap between these rollers and thus the thickness of the produced dough strip.

It is advantageously foreseen that the pivot device comprises a pivot lever, such that the pivot lever can be pivoted about a pivot axis, in particular by means of a hydraulic or pneumatic cylinder or electro-mechanically, and such that the support of the draw-in roller and/or the forming roller and/or the discharge roller is mounted in the pivot lever, such that upon pivoting the pivot lever the distance of the axis of the draw-in roller and/or of the forming roller and/or of the discharge roller can be adjusted and selected in relation to the respective other rollers.

To be able to advantageously withdraw dough from the rollers, it is foreseen that the device comprises a first scraper, such that the first scraper is contiguous with the circumference of the forming roller, such that dough can be removed from the circumference of the forming roller by means of the first scraper and such that, in particular, the first scraper is arranged so that it can be pivoted or slid and can be removed from the circumference of the forming roller. Because of the arrangement of the first scraper on the circumference of the forming roller, it becomes possible to remove dough completely from the forming roller and to advantageously convey it away in the dough chamber or keep it away from the discharge roller. In addition, because of the arrangement of the first scraper on the circumference of the forming roller, the thickness of the produced dough strip can be advantageously predetermined and a smooth surface of the produced dough strip can be obtained.

The produced dough strip can be easily removed from the discharge roller, in that the device comprises a second scraper, such that the second scraper is contiguous with the circumference of the discharge roller and dough, in particular the formed dough strip, can be removed from the discharge roller and such that, in particular, the second scraper is positioned so that it can be pivoted or slid and can be removed from the circumference of the discharge roller.

In addition, the surface of the dough strip is smoothed or positively influenced by the second scraper, which is contiguous with the circumference of the discharge roller, and in addition dough or remnants of dough are prevented from remaining suspended on the circumference of the discharge roller.

To further improve cleaning of the device, it is advantageously foreseen that the first scraper and/or the second scraper are positioned on the device so that they are removable, preferably manually, and in particular can be withdrawn on a spike.

To further facilitate access to the rollers and to better permit cleaning of the device, it is foreseen that the draw-in roller comprises a filler funnel, which can be pivoted about a pivot axis.

Access to the dough chamber and thus its cleaning is facilitated in that the cover shields are removably fastened to the device.

To simplify fastening the cover shields and to effectively insulate the dough chamber, the device is designed to comprise at least one clamping cylinder, preferably three clamping cylinders, which preferably are arranged in the support housing, such that the clamping cylinder of at least one of the cover shields can be pressed onto the draw-in roller, the forming roller and/or the discharge roller in the direction of the axis of the draw-in roller, the forming roller and/or the discharge roller.

It is advantageously foreseen that the draw-in roller and/or the forming roller and/or the discharge roller are hollow in configuration, such that the device comprises at least one, in particular three, lengthwise clamping axles, such that the clamping axle, in particular one of the three clamping axles in each case, can be directed through the draw-in roller or the forming roller or the discharge roller and the respective roller is rotatably mounted on the clamping axle, in particular the respective clamping axle, such that the clamping axle is connected with the clamping cylinder, in particular all clamping axles, by means of a clamping flange, and at least one of the cover shields, in particular the cover shield opposite the support housing with respect to the rollers, is connected with the clamping axle, in particular removably, in such a way that upon actuating the clamping cylinder at least one of the cover shields, in particular the cover shield opposite the support housing, can be pressed onto the draw-in roller, the forming roller and the discharge roller in the direction of the axle of the draw-in roller, the forming roller and the discharge roller.

To be able to determine that the device is ready for operation before setting it in motion, it is foreseen that the device, in particular the clamping cylinder, comprises a number of sensors, with which it is possible to ascertain the position and/or the presence of the draw-in roller and/or of the forming roller and/or of the discharge roller and/or of the cover shield and/or of the first scraper and/or of the second scraper.

It is also possible for the sensors to assure that none of the parts or elements of the device are absent or incorrectly installed, so that malfunctioning or the escape of dough or incorrectly produced dough strips can be prevented.

To be able to discharge the produced dough strip easily from the device and to incorporate additional processing stations or additional processing steps, it is foreseen that the device comprises a conveyor device, in particular a conveyor belt, which is installed downstream from the discharge rollers and the formed dough strip can be discharged out of the device by means of the conveyor device.

It is advantageously foreseen that the device comprises three drives, such that the draw-in roller and the forming roller and the discharge roller each can be driven separately, preferably at different rotation speeds. The rotation speeds and the circumferential speeds of the rollers can be varied and adjusted in such a manner and thus the desired penetration can be selected. In addition, it is advantageous to vary the rotation speeds and thus the circumferential speeds of the rollers among themselves. This makes it possible to fulfill optimal prerequisites with different dough varieties or dough consistencies.

In an advantageous embodiment it is foreseen that the draw-in roller and/or the forming roller and/or the discharge roller comprise various profiling, such that in particular the draw-in roller and forming roller have a profiled circumference and the discharge roller is smooth in configuration.

Further advantages and configurations of the present teaching can be seen from the description and the associated drawings.

### BRIEF DESCRIPTION OF THE DRAWINGS

The present teaching is schematically depicted hereinafter with reference to the particularly advantageous embodiments, which however are not to be considered restrictive, in the drawings and it is described by way of example with reference to the drawings, which are as follows.

FIG. 1 shows an isometric view of a preferred embodiment of the inventive device,

FIG. 2 shows a section view of an inventive device with filler funnel,

FIG. 3 shows an embodiment of the present teaching according to FIG. 2 with filler funnel mounted upon it,

FIGS. 4 through 7 show an advantageous embodiment of the present teaching in various functional conditions,

FIG. 8 shows a section view of an inventive embodiment of the forming roller,

FIG. 9 shows an overhead view of an inventive device with three clamping cylinders,

FIG. 10 shows a preferred embodiment of the rollers with cover shields and clamping cylinders in an exploded view,

FIG. 11 shows an alternative embodiment with a clamping cylinder and three clamping axles,

FIG. 12 shows an alternative embodiment of a clamping cylinder for pressure mounting of the cover shield, and

FIG. 13 shows an embodiment of a pivotable scraper.

### DETAILED DESCRIPTION

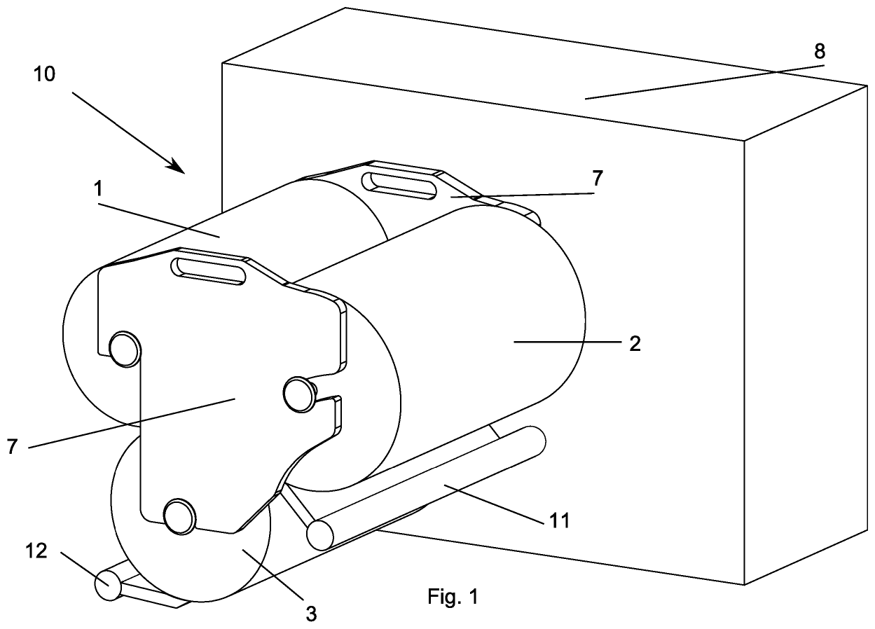

Shown in FIG. 1 is an inventive device 10 in isometric view. The device 10 comprises a draw-in roller 1, a forming roller 2 and a discharge roller 3. The draw-in roller 1, forming roller 2 and discharge roller 3 are each rotatably mounted about their axis. The device 10 further comprises a drive with which the draw-in roller 1, the forming roller 2 and the discharge roller 3 are driven. The device 10 comprises two cover shields 7, which each are arranged laterally on the end faces of the rollers and are contiguous with them. The device 10 further comprises a first scraper 11, which is contiguous with the forming roller 2 on its circumference, and a second scraper 2, which is contiguous with the discharge roller 3. The first scraper 11 and the second scraper 12 have the same width as the rollers, that is, with the draw-in roller 1, forming roller 2 and discharge roller 3. The draw-in roller 1, forming roller 2 and discharge roller 3 are each supported in a floating manner in a support housing 8. The supports or support positions of the individual rollers, that is, the support positions of a floating support or the firm or loose mounting of the support of the rollers, are arranged on one side of the device 10 inside the support housing 8.

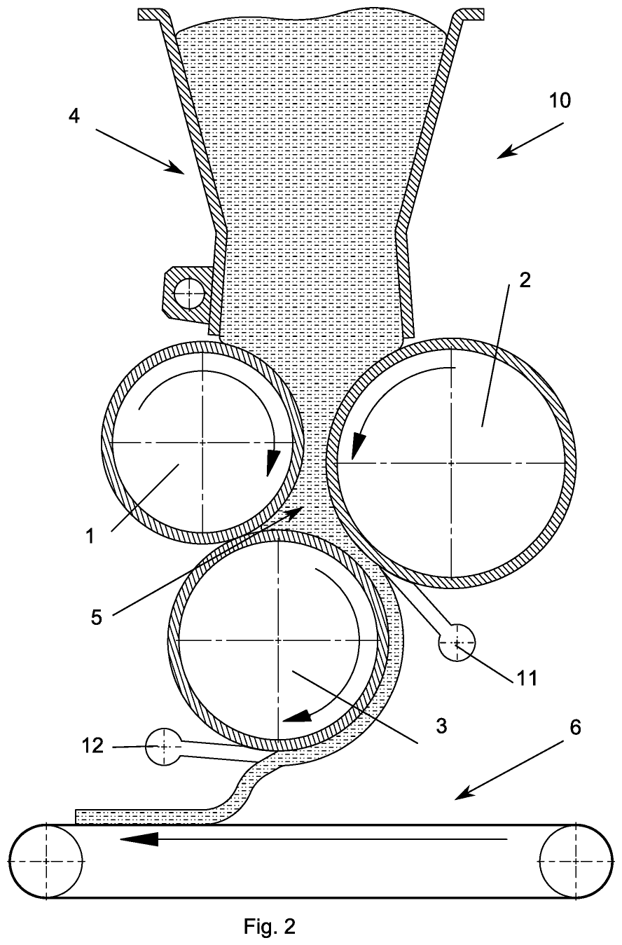

FIG. 2 shows a section view of an embodiment of the inventive device 10. The device 10 comprises a dough draw-in device 4, which is configured as a dough funnel, with which the dough is introduced into the device 10. The axis of the draw-in roller 1 is arranged at a distance to the axis of the forming roller 2 in the region of the dough draw-in device 4. Because of the distance of the axes of the draw-in roller 1 and the forming roller 2 to one another, there is a gap between the rollers through which the dough is conveyed from the dough supply device 4 to the circumference of the draw-in roller 1 and of the forming roller 2. The axes of the draw-in roller 1, of the forming roller 2 and of the discharge roller 3 are arranged parallel to one another in a mutually spaced manner, so that a dough chamber 5 is configured between the draw-in roller 1, the forming roller 2 and the discharge roller 3. As depicted in FIG. 2, by rotating the draw-in roller 1, for example in the clockwise direction, and rotating the forming roller 2 in a direction contrary to the draw-in roller 1, that is, in counter-clockwise direction, dough is conveyed from the dough supply device 4 into the dough chamber 5. The axes of the forming roller 2 and of the discharge roller 3 are arranged at a distance from one another, so that between the forming roller 2 and the discharge roller 2 a gap or a distance on their circumference is formed between the two rollers. No distance or only a slight distance is formed between the circumference of the draw-in roller 1 and of the discharge roller 3, so that no dough can escape from the dough chamber 5 between the draw-in roller 1 and the discharge roller 3. By rotating the discharge roller 3 in the same rotation direction as the draw-in roller 1, dough from the dough chamber 5 is now released from the device 10 between the forming roller 2 and the discharge roller 3. By discharging dough from the dough chamber 5, a dough strip with a predetermined thickness is produced. The thickness of the dough strip 2 can be predetermined or selected by adjusting the distance between forming roller 2 and the discharge roller 3. The device 10 further comprises a first scraper 11, which is contiguous with the circumference of the forming roller 2 in the region of the outlet of the dough chamber 5. The first scraper 11 thus makes possible the complete severing of the formed dough strip from the forming roller 2 and simultaneously smooths the surface of the dough strip formed between the forming roller 2 and the discharge roller 3. The device 10 likewise comprises a second scraper 12, which is contiguous with the circumference of the discharge roller 3 and strips off or prevents dough remnants of the formed dough strip from the discharge roller from adhering to the discharge roller 3. In this embodiment a conveyor device 6, in this case a conveyor belt, is situated downstream from the discharge roller 3, and on this belt the formed dough strip is placed and discharged from the device 10 along the transport direction depicted in FIG. 2 by an arrow.

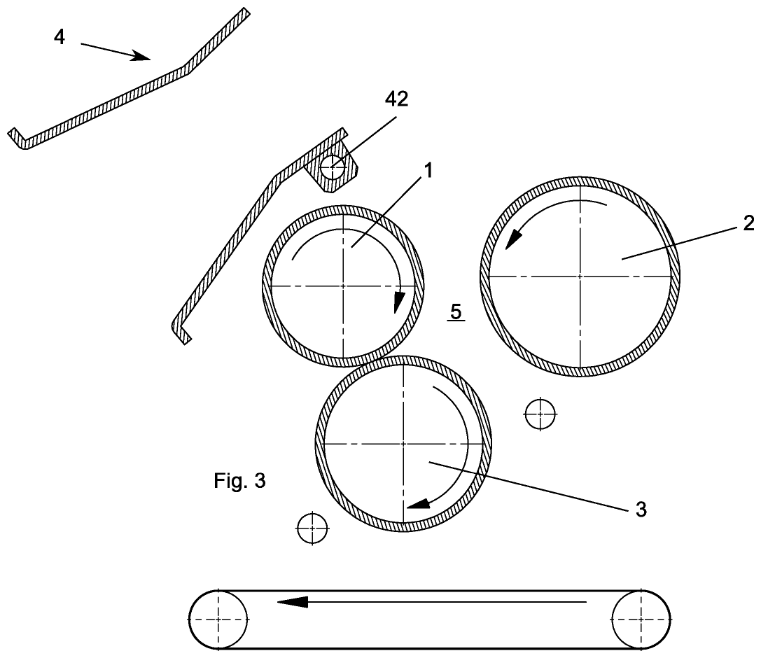

FIG. 3 depicts the inventive device 10 according to FIG. 2 in an additional functional condition. To facilitate cleaning of the device 10, the dough supply device 4, which is configured as a dough funnel, can be pivoted about a pivot axis 42 and thus access to the dough chamber 5 or to the draw-in roller 1 and to the forming roller 2 can be facilitated.

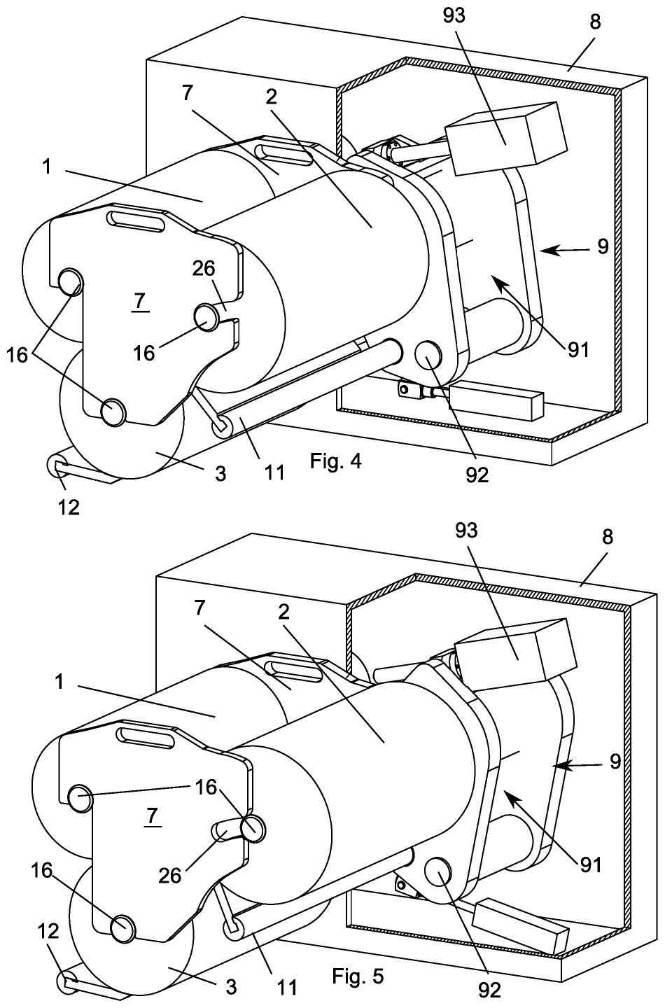

Shown in FIG. 4 is an additional embodiment of the inventive device 10 in a perspective view. The supports of the draw-in roller 1, of the forming roller 2 and of the discharge roller 3 are arranged in a support housing 8. The support housing 8 is hermetically insulated, thus preventing dough or cleaning agents from penetrating into the support housing 8 and damaging the supports of the forming roller 1, of the discharge roller 3 or of the draw-in roller 1. The device 10 comprises a pivot device 9, on which the forming roller 2 is pivotably mounted. The pivot device 9 comprises a pivot lever 91, which comprises two flanges arranged at a distance from one another, which can be pivoted jointly about a pivot axis 92. The pivot device 9 further comprises a pneumatic cylinder 93, which is arranged on the end of the pivot lever 91 opposite the pivot axis 92. By modifying the lift height of the piston of the pneumatic cylinder 93, the pivot lever 91 is pivoted about the pivot axis 92. The forming roller 2 is arranged on the pivot lever 91, such that the support of the forming roller 2 is integrated in the pivot lever 91. By pivoting the pivot lever 91 about the pivot axis 92, the forming roller 2 is thus pivoted with it and the distance of the axis of the forming roller 2 to the axis of the draw-in roller 1 or to the axis of the discharge roller 3 is modified. The first scraper 11 is likewise arranged on the pivot lever 91, so that upon pivoting the pivot lever 91 about the pivot axis 92, the first scraper 11 is pivoted along with the forming roller 2. By modifying the distance of the forming roller 2 to the respective other rollers or to the discharge roller 3, the distance between the circumference of the discharge roller 3 and of the forming roller 2 is modified and thus the thickness of the dough strip, which is discharged from the dough chamber 5, is selected or modified. In addition, it is possible, by actuating the pneumatic cylinder 93, to pivot the pivot lever into a position in which the forming roller 2 is at a maximum distance to the other rollers, that is, the draw-in roller 1 and the discharge roller 3, and access to the dough chamber 5 is facilitated (FIG. 5). As shown in FIG. 4, the cover shields 7 can be suspended on the shafts or axles of the rollers, so that after pivoting the pivot lever 91 and thus the pivoting of the forming roller 2 and sliding out the axle or shaft of the forming roller 2 out of a guide 26 configured in the cover shield 7, they can be raised from the axles or shafts of the discharge roller 3 and of the draw-in roller 2. By removing the cover shield 7, access to the dough chamber 5 is further facilitated or improved and thus cleaning and maintenance of the discharge roller 3, of the forming roller 2 and of the draw-in roller 1 are simplified (FIG. 7).

Optionally the first scraper 11 and/or the second scraper 12 can be positioned removably on the device 10 or the pivot lever 91. As depicted in FIGS. 2 through 7, the first scraper 11 and the second scraper 12 can be positioned on a spike that is positioned on the device 10 or on the pivot device 9, and can be mounted on it, for example in a withdrawable manner. Thanks to the removal or withdrawal of the first scraper 11 and second scraper 12, they can be cleaned separately and access to the dough chamber 5 is further simplified (FIG. 7).

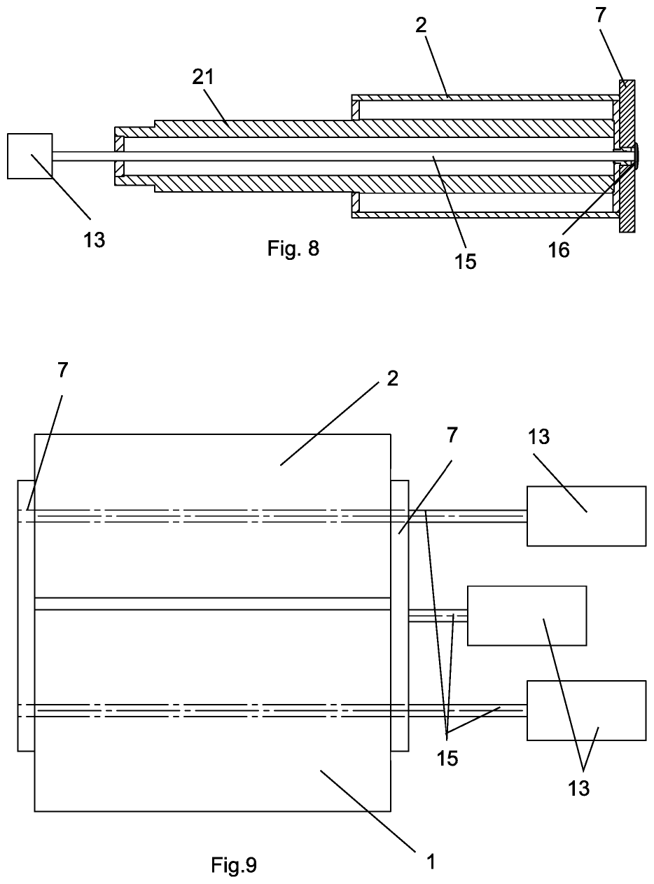

Shown in FIG. 8 is an advantageous embodiment of the forming roller 2 or the support of the forming roller 2. The forming roller 2 is hollow and positioned on a support shaft 21. The support shaft 21 itself is mounted in the support housing 8, which is not shown in the illustration, and thus the forming roller 2 comprises alongside the chamber 5 a floating support, which is positioned in the support housing 8. The support shaft 21 itself is likewise hollow in configuration and is penetrated by a clamping axle 15. The clamping axle 15 thus passes completely through the support shaft 21 and extends from the support housing 8 to the cover shield 7 opposite the support housing 8. The clamping axle 15 comprises, on its end close to the cover shield 7, a mushroom-shaped widening 16, which is larger than the recess of the cover shield 7. A clamping cylinder 13 is positioned on the end of the clamping axle 15 opposite the mushroom-shaped widening 16. The clamping axle 15 is drawn in through the clamping cylinder 13 in the direction of the support housing 8 or in the direction of the clamping cylinder 13, and thus the cover shield 7 is pressed against the forming roller 2 or in the direction of the dough chamber 5 and thus the dough chamber 5 is advantageously laterally insulated.

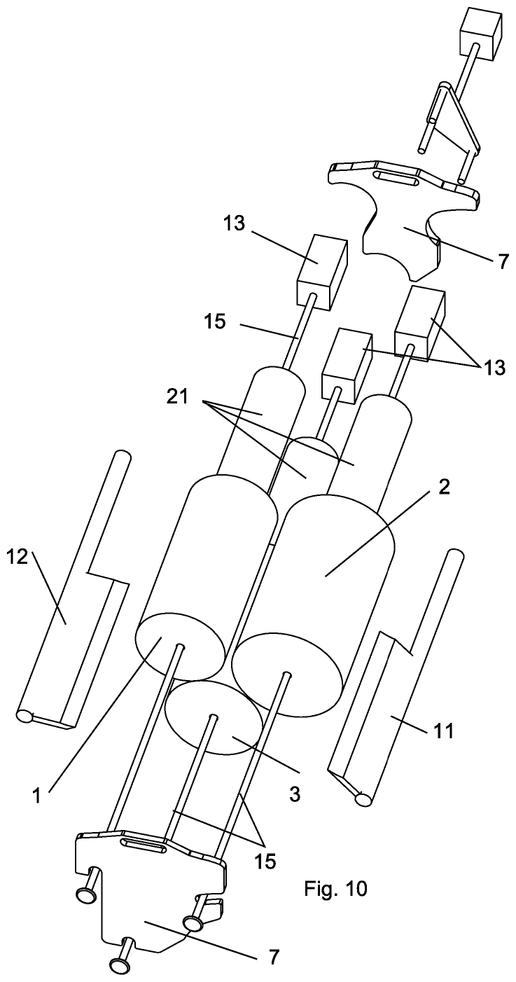

As an alternative, as shown in FIGS. 9 and 10, the device 10 comprises three clamping cylinders 13 and three clamping axles 15, which are each drawn through one of the rollers, that is, the forming roller 2, the discharge roller 3 and the draw-in roller 1, and each, with a mushroom-shaped widening 16, press the cover shield 7 against the rollers.

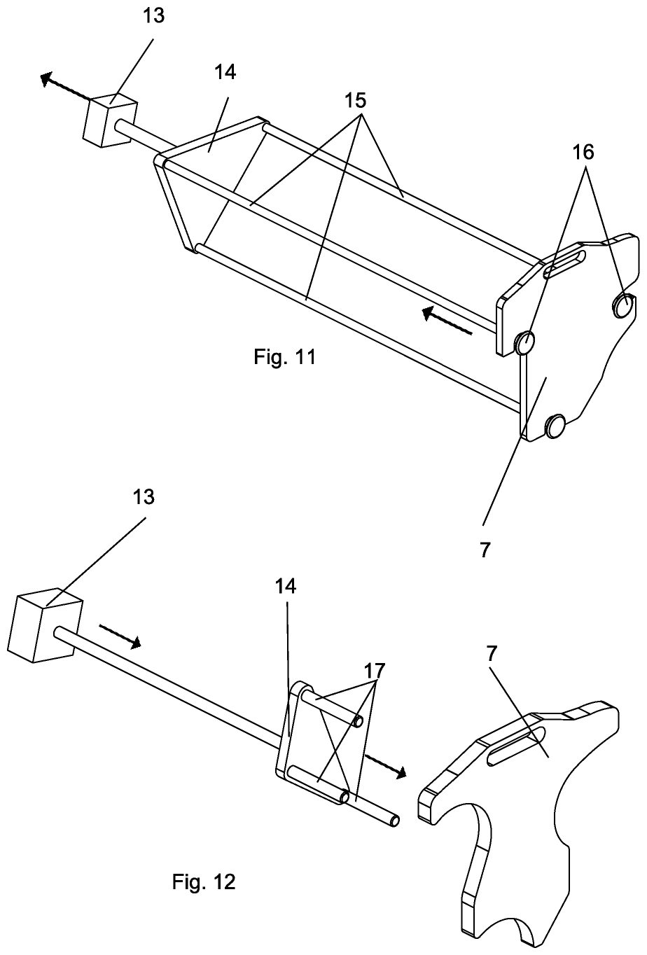

Alternatively, as depicted in FIG. 11, the three clamping axles 15, each of which passes through one of the rollers, that is, the draw-in roller 1, the discharge roller 3 or the forming roller 2, can be positioned on a clamping flange 14 and the clamping flange 14 can be connected with a clamping cylinder 13.

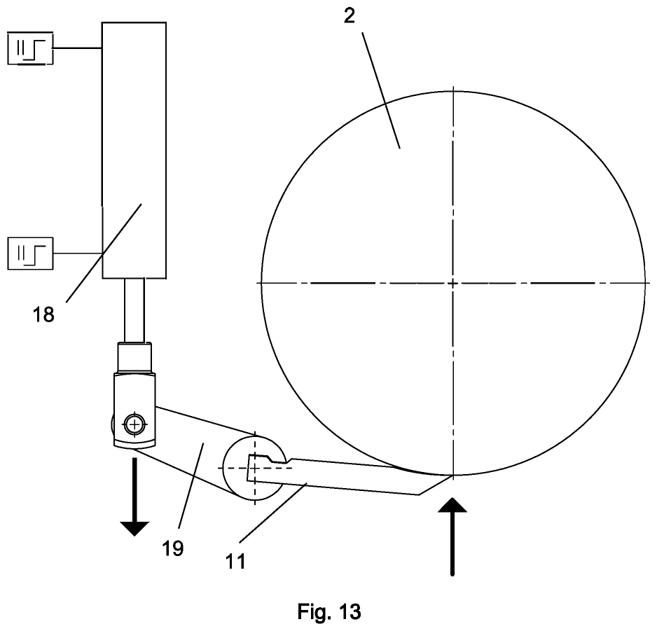

FIG. 12 illustrates an optional configuration of one part of the device 10 in an isometric drawing. In an optional embodiment, the cover shield 7, which is positioned on the side of the dough chamber 5 alongside the support housing 8, can likewise be pressed against the rollers, that is, the draw-in roller 1, the forming roller 2 and the discharge roller 3, by a clamping cylinder 13, which is connected with a clamping flange 14. For this purpose the clamping flange 14, as shown in FIG. 12, can comprise three pressure rods 17, which apply the pressure of the clamping cylinder 13 to the cover shield 7, distributing it uniformly, so that the cover shield 7 is uniformly pressed against the rollers. This also allows the dough chamber 5 to be insulated in a simple manner on the side facing the support housing 8.

FIG. 13 shows an optional configuration of the first scraper 11. It can be foreseen optionally that the first scraper 11 and/or the second scraper 12 are pivotably mounted on a pivot support 25. The device 10 can comprise a cylinder 19, which is connected with the first scraper 11 by a pivot lever 18. If the piston rod of the cylinder 19 is pushed outward, and thus the height is increased, the pivot lever is pivoted in the direction indicated by the arrow in FIG. 13 and the scraper 11 is pressed on the circumference of the forming roller 2. Then, if the cylinder 19 and thus the pivot lever 18 are moved contrary to the direction shown in FIG. 13, the first scraper 11 is removed from the circumference of the forming roller 2. As a result of the pivoting of the first scraper 11, cleaning of the circumference of the forming roller 2 and simplified or improved access to the dough chamber 5 become possible. Alternatively to the embodiment of the first pivot lever 11 shown in FIG. 13, only the second pivot lever 12, likewise or optionally, can analogously be pivotably contiguous with the circumference of the discharge roller 3, and can be pivoted with the cylinder by a corresponding pivot lever.

Hereinafter, the functioning of the device is described by way of example, with reference to a preferred embodiment as shown in FIGS. 3 through 7.

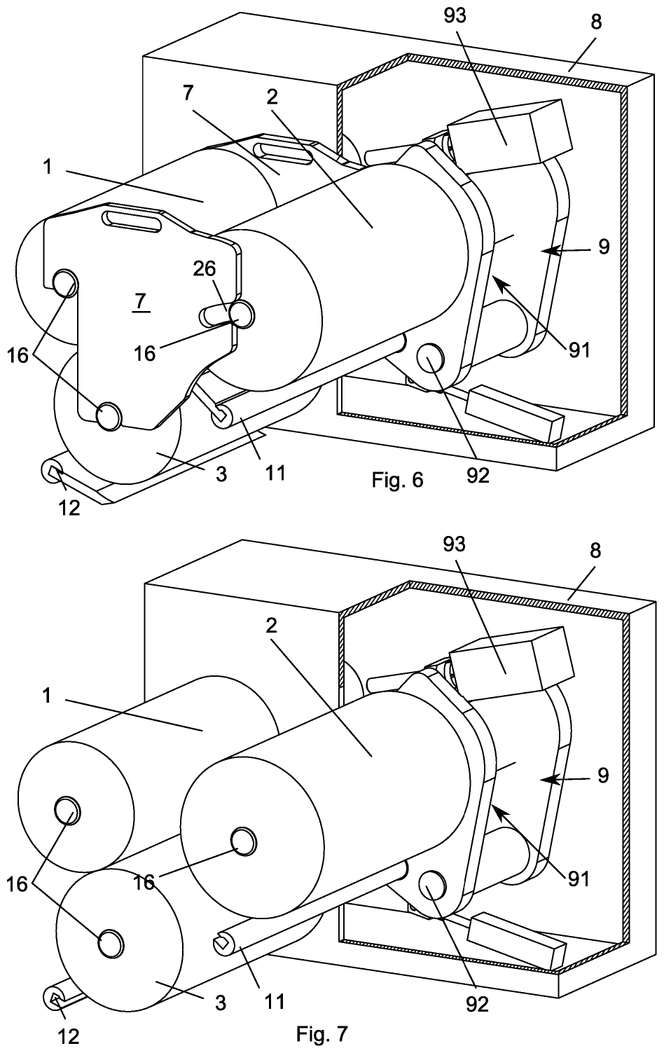

As shown in FIG. 3, in operating position the axles of the draw-in roller 1, of the forming roller 2 and of the discharge roller 3 are situated at a distance from one another such that, between the rollers, a dough chamber 5 (FIG. 2) is formed. The dough chamber is delimited laterally in each case by two cover shields 7, one on the end of the dough chamber 5 close to the support housing 8 and one on the side of the dough chamber 5 farther from the support housing 8. The first scraper 11 is contiguous with the circumference of the forming roller 2 and the second scraper 12 is contiguous with the circumference of the discharge roller 3. The cover shields 7 are removably fastened on the axles or shafts of the draw-in roller 1, of the forming roller 2 and of the discharge roller 3. The forming roller 2 can be pivoted by the pivot lever 91 about the pivot axis 92, and thus the distance of the forming roller 2 from the draw-in roller 1 and discharge roller 3 is modifiable. By modifying the distance of the forming roller 2 from the other rollers, the thickness of the produced dough strip, which is dispensed between the forming roller 2 and the discharge roller 3 from the dough chamber 5, can be selected at the defined thickness. The cover shields 7 comprise a guide 26, in which the axle or shaft of the forming roller 2 is directed about the pivot axis 92 during the pivot movement of the pivot lever 91. As shown in FIG. 5, the forming roller 2 can be pivoted by the pivot lever 91 about the pivot axis 92 and the shaft or axle of the forming roller 2 can move out of the guide 26. By increasing the distance of the forming roller 2 from the draw-in roller 1 and the discharge roller 2 by means of the pivot lever 91, the size of the dough chamber 5 is increased. To further simplify cleaning of the forming roller 2 and of the discharge roller 3 or the dough chamber 5, the first scraper 11 and the second scraper 12, as shown in FIG. 6, pivot about their pivot axis and thus are each removed from the circumference of the forming roller 2 or from the circumference of the discharge roller 3, so that the access to the circumference of the rollers and access to the dough chamber 5 are further facilitated.

Because the shaft or axle of the forming roller 2 exits from the guide 26 of the cover shields 7, the cover shields 7 in each case, as shown in FIG. 7, can additionally be removed and access to the dough chamber 5 is then free on the side of the dough chamber 5 opposite the support housing 8. Because of the floating support of the draw-in roller 1, of the forming roller 2 and of the discharge roller 3 on a side close to the dough chamber 5, it thereby becomes possible, on a so-called service side, to simplify cleaning of the dough chamber 5 and of the draw-in roller 1, the forming roller 2 and the discharge roller 3 and thus to ensure greater hygienic cleanliness of the device 10. To further facilitate access to the dough chamber 5 and to the rollers, it is possible, as shown in FIG. 7, that the first scraper 11 and the second scraper 12 are secured on a spike and are withdrawn by it or removed from the device 10.

Optionally the device 10 can comprise a number of sensors, which record the condition, the position or presence of the cover shields 7, of the draw-in roller 1, of the forming roller 2, of the discharge roller 3, of the first scraper 11 and/or of the second scraper 12, and upon shifting the position of the individual parts or the absence of individual parts of the device 10, can inform the user of this or possibly can prevent stoppage or start-up of the device 10.

As another option, the clamping cylinders 13 can each comprise a position and/or pressure sensor, with which the condition or presence of the individual elements of the device 10 can be determined or recorded.

Alternatively, by means of a hydraulic cylinder or pneumatic cylinder or electro-mechanically, the pivot lever 18 can be pivoted and/or the clamping cylinder 13 can be configured as a hydraulic cylinder or pneumatic cylinder or the clamping axles 15 can be actuated electro-mechanically.

In an additional optional embodiment of the inventive device 10, the device 10 comprises three drives. By means of three drives, then, the draw-in roller 1, the forming roller 2 and the discharge roller 3 can each be driven separately. By means of the separate drives it is possible to drive the draw-in roller 1, the forming roller 2 and the discharge roller 3 at different rotation speeds and thus in different regions of the device various dough movements can be achieved.

It is also advantageous if the draw-in roller 1 and/or the forming roller 2 and/or the discharge roller 3 can comprise a different profiling. Thus, for example, it is possible for the draw-in roller 1 and the forming roller 2 to comprise a profiled circumference in order to achieve good cohesion of the dough or to cause advantageous formation of the dough. The discharge roller 3 can also be configured as smooth in order to provide a smooth surface of the dough strip.

1. A device for forming a dough strip, comprising a dough supply device, by which dough can be introduced into the device, a draw-in roller which can be rotated about its axis, a forming roller which can be rotated about its axis, a discharge roller which can be rotated about its axis, and at least one drive, by which the draw-in roller and/or the forming roller and/or the discharge roller can be driven,
wherein the axes of the draw-in roller, the forming roller, and the discharge roller are arranged parallel to one another in a mutually spaced manner, and a dough chamber is formed between the draw-in roller, the forming roller, and the discharge roller,
whereby the device has two cover shields which laterally delimit the dough chamber, in particular on the end faces of the draw-in roller, the forming roller, and the discharge roller,
whereby the draw-in roller and the forming roller are arranged in a mutually spaced manner in the region of the dough supply device such that dough can be introduced from the dough supply device onto the circumference of the draw-in roller and the forming roller4 and into the dough chamber by rotating the draw-in roller and the forming roller, and
whereby the forming roller and the discharge roller are arranged in a mutually spaced manner such that dough can be discharged out of the dough chamber as a formed dough strip with a defined thickness between the forming roller and the discharge roller,
wherein the draw-in roller, the forming roller and the discharge roller are supported in a floating manner, and the draw-in roller, the forming roller and the discharge roller are supported on one side of the device adjacently to the dough chamber.

2. The device according to claim 1, wherein the supports of the draw-in roller, the forming roller and the discharge rollers are arranged in a support housing.

3. The device according to claim 1, wherein the device includes a pivot device, such that the draw-in roller and/or the forming roller and/or the discharge roller are pivotable by the pivot device, such that the distance of the axle of the draw-in roller and/or the forming roller and/or the discharge roller from the axles of at least one of the respective other rollers is adjustable.

4. The device according to claim 3, wherein the pivot device includes a pivot lever, such that the pivot lever can pivot about a pivot axis, and such that the support of the draw-in roller and/or the forming roller and/or the discharge roller is mounted in the pivot lever, such that, upon pivoting of the pivot lever, the distance of the axis of the draw-in roller and/or the forming roller and/or the discharge roller from the respective other rollers can be adjusted and selected.

5. The device according to claim 1, wherein the device includes a first scraper, such that the first scraper is contiguous with the circumference of the forming roller, such that dough can be removed from the circumference of the forming roller by the first scraper and such that the first scraper is mounted so that it can be pivoted or pushed and can be moved away from the circumference of the forming roller.

6. The device according to claim 1, wherein the device includes a second scraper such that the second scraper is contiguous with the circumference of the discharge roller, and dough can be removed from the discharge roller and such that the second scraper is mounted so that it can be pivoted or pushed and can be moved away from the circumference of the discharge roller.

7. The device according to claim 5, wherein the first scraper and/or the second scraper are positioned on the device so that they can be pulled away on a spike.

8. The device according to claim 1, wherein the supply device includes a filler funnel, which can be pivoted about a pivot axis.

9. The device according to claim 1, wherein the cover shields are removably fastened on the device.

10. A The device according to claim 1, wherein the device includes at least one clamping cylinder, such that the clamping cylinder of at least one of the cover shields can be pressed onto the draw-in roller, the forming roller and the discharge roller in the direction of the axis of the draw-in roller and/or the forming roller and/or the discharge roller.

11. The device according to claim 10, wherein the draw-in roller and/or the forming roller and/or the discharge roller are hollow, such that the device includes at least one lengthwise lengthwise clamping axle,
such that the clamping axle is inserted through the draw-in roller or the forming roller or the discharge roller and the respective roller is rotatably mounted on the clamping axle,
such that the clamping axle is connected with the clamping cylinder by a clamping flange and at least one of the cover shields is connected with the clamping axle in such a way that upon actuation of the clamping cylinder, at least one of the cover shields can be pushed onto the draw-in roller, the forming roller and the discharge roller in the direction of the axis of the draw-in roller, the forming roller and the discharge roller.

12. A The device according to claim 1, wherein the device includes a number of sensors with which the position and/or the presence of the draw-in roller and/or the forming roller and/or the discharge roller and/or the cover shield and/or the first scraper and/or the second scraper can be determined.

13. The devices according to claim 1, wherein the device includes a conveyor device which is positioned downstream from the discharge roller and the formed dough strip can be discharged from the device the conveyor device.

14. The device according to claim 1, wherein the device includes three drives, such that the draw-in roller and the forming roller and the discharge roller can be driven, separately in each case.

15. The device according to claim 1, wherein the draw-in roller and/or the forming roller and/or the discharge roller includes a different profiling.
